(19) United States
(12) Patent Application Publication
(10) Pub. No.: US 2005/0169283 A1
(43) Pub. Date: Aug. 4, 2005

(54) Internet access through conventional telephones

(75) Inventor: Dinesh K. Jindal, Naperville, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/768,542

(22) Filed: Jan. 30, 2004

(51) Int. Cl. H04L 12/66

(52) U.S. Cl. 370/401; 370/352; 370/466

(57) ABSTRACT

A method of providing real-time Internet access to a caller using only a standard telephone and plain old telephone service. The method includes receiving at a local switch a destination number representing a request for Internet access from the caller; routing the call to an Internet server for providing the Internet access; converting the destination number to a URL at the Internet server; routing the URL from the Internet server to the Internet; receiving a response from the Internet at the Internet server, the response including digital information; and converting the digital information in the response to a voice message, the voice message including information from the Web site and prompts for the caller; and routing the voice message to the caller.

### FIELD OF THE INVENTION

The present invention relates generally to telecommunications, and, more particularly, to a method and system for providing Internet access to users of plain old telephone service.

### BACKGROUND OF THE INVENTION

The Internet is a global connection of computer networks, also referred to as the “Net,” which share a common addressing scheme. The World Wide Web is an Internet system to distribute graphical, hyper-linked information, based on the hypertext transfer protocol (HTTP). The World Wide Web (the “Web” or “WWW” for short) is a hypertext system that operates over the Internet. Generally, to view the information on the Web, Internet users use a computer software program called a Web browser to retrieve pieces of information (called “documents” or “Web pages”) from Web servers (or “Web sites”) and view them on a computer screen. Users can then follow hyperlinks on the page to other documents or even send information back to the server to interact with it. The act of following hyperlinks is often called “surfing” the Web. Other services on the Internet include Internet Relay Chat and Newsgroups.

Thus, a user may currently access the Internet from a personal computer, a PDA, or a wireless phone. However, the Internet is still not available to users of plain old telephone service (POTS) via a standard telephone, even though these circuit-based telephones are still the most common mode of communication. Thus, there is a need for a system and method for providing Internet access to standard telephone users by entering Web site addresses (URLs) through a telephone keypad.

### SUMMARY OF THE INVENTION

In accordance with one aspect of the present invention, a method of providing real-time Internet access to a caller using plain old telephone service is provided. The method includes receiving at a local switch a destination number representing a request for Internet access from the caller; routing the call to an Internet server for providing the Internet access; converting the destination number to a URL (universal resource locator) at the Internet server; routing the URL from the Internet server to the Internet; receiving a response from the Internet at the Internet server, the response including digital information; and converting the digital information in the response to a voice message, the voice message including information from the Web site and prompts for the caller; and routing the voice message to the caller.

In accordance with another aspect of the present invention, a system for providing real-time Internet access to a caller using plain old telephone service is provided. The system includes means for receiving at a local switch a destination number representing a request for Internet access from the caller; means for routing the call to an Internet server for providing the Internet access; means for converting the destination number to a URL at the Internet server; means for routing the URL from the Internet server to the Internet; means for receiving a response from the Internet at the Internet server, the response including digital information; and means for converting the digital information in the response to a voice message, the voice message including information from the Web site and prompts for the caller; and routing the voice message to the caller.

It is, therefore, an object of the present invention to provide a link between the voice and the data world, by allowing users of plain old telephone service to access any Web site on the Internet.

It is a further object of the present invention to provide a method and system for processing a sequence of numbers that have been entered by a user on a standard telephone keypad, where the sequence of numbers acts as the URL (Web address) of a Web site.

It is yet a further object of the present invention to provide a method and system for interpreting an intended phone number as an instruction to retrieve a Web page for a user.

It is yet a further object of the present invention to provide a method and system for text to speech conversion, thereby allowing any Web page to be read to a telephone user.

Further objects and features of the present invention will be apparent from the following specification and claims when considered in connection with the accompanying drawings, illustrating the preferred embodiments of the invention.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram of a telecommunications environment suitable for implementing aspects of the present invention.

FIG. 2 is an overall flow chart for describing an algorithm for implementing aspects of the present invention.

### DETAILED DESCRIPTION OF THE PREFERRED EMBODIMENTS

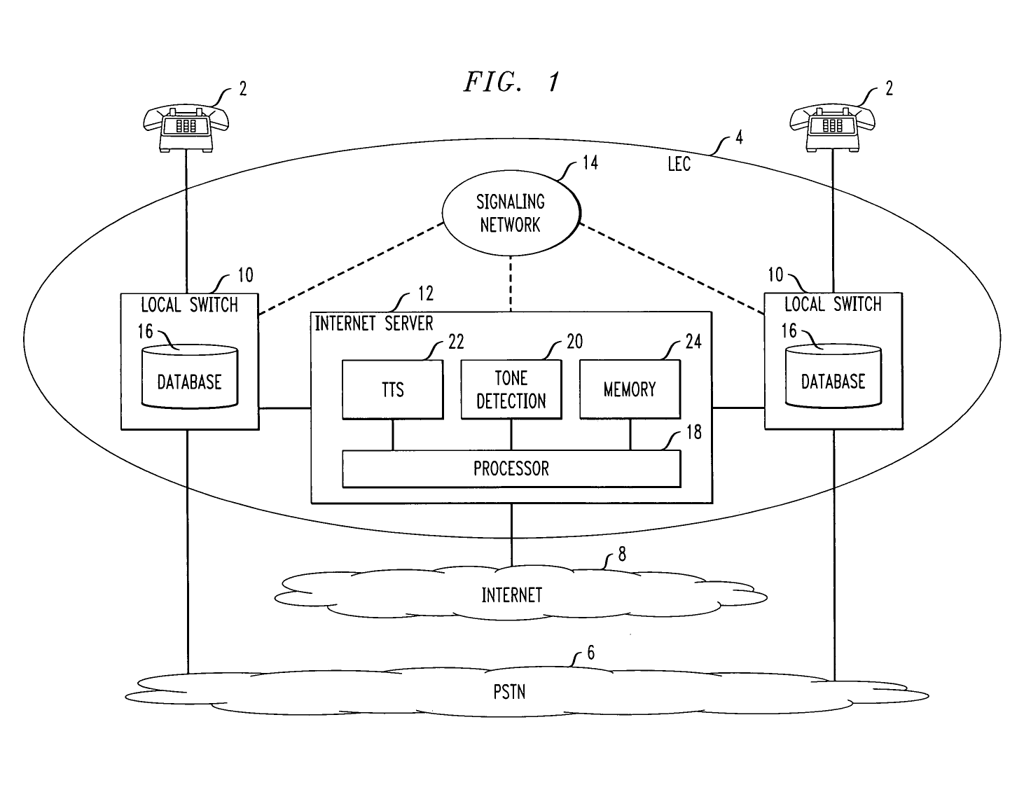

FIG. 1 is a block diagram of a telecommunications network. Attached to the network is any number of conventional telephones 2, which are connected to a local exchange carrier network 4. The local exchange carrier (LEC) network 4 is connected to the Public Switched Telephony Network (PSTN) 6 and the Internet 8.

The PSTN 6 refers to the public phone networks as we know them. The PSTN 6 is composed of switches and T1/E1 trunks, central offices, etc., as known to those skilled in the art. The PSTN 6 uses circuit-switched technology, in which necessary resources are allocated (dedicated) for the duration of a phone call.

An IP (Internet Protocol) network such as the Internet 8, in contrast to the PSTN 6, is composed of nodes of computers, servers, routers, and communications links, etc. It employs packet-switching technology that decomposes data (e.g., voice, Web sites, e-mail messages into IP packets. Each packet is then transmitted over an IP network to a destination identified by an IP address and reassembled at the destination. An IP transmission is completed without pre-allocating resources from point to point.

In accordance with the present invention, Internet access calls from a caller through the telephone 2 are processed in the LEC network 4. The establishment of connections to the Internet 8 is executed under the control of an intelligent network as shown in the block diagram of the LEC network 4. The LEC network 4 includes any number of local switches 10 connected to the telephones 2 and at least one Internet server 12. A signaling network 14, such as Common Channel Signaling System No. 7 (i.e., SS7 or C7), transmits data messages among the local switches 10 and the Internet server 12.

A string of numbers and/or characters entered by the caller through the keypad of the telephone 2 is processed in the Internet server 12, which converts the string into a URL that can be used for routing the call to the Internet 8. A URL (Universal Resource Locator) is the address of a file (resource) accessible on the Internet 8. The type of file or resource depends on the Internet application protocol. Using the Web's protocol (Hypertext Transfer Protocol or HTTP), the resource can be an HTML page, an image file, a program such as a common gateway interface application or Java applet, or any other file supported by HTTP. The URL contains the name of the protocol required to access the resource, a domain name that identifies a specific computer on the Internet, and a pathname (hierarchical description of a file location) on the server. On the Web, an example of a URL is: http://www.lucent.com, which describes the type of access method being used (http) and the server location which hosts the Web site (www.lucent.com). An HTTP URL can be for any Web page, not just a home page, or any individual file.

In accordance with the principles of the present invention, the local switch 10 preferably includes a routing database 16 for dialed address or number (DN) to routing translation. The database 16 preferably stores not only the routing number to permit the call to be completed using the known routing arrangements through the PSTN 6, but also provides an indication that a certain sequence of numbers relates to an Internet access call. The database 16 includes routing tables which store instructions for the various types of dialed number conversion that may need to take place, as well as what the next hop (node) will be in order to route (send) the call, depending upon the pattern of the incoming number. For example, calls make take a different route if the first digit is a 1 or a 0 or if the first few digits are 800, 888 or 911.

Accordingly, entries may be added to the routing table, such as “If the number starts with *0, then route call to the Internet server.” Moreover, depending upon the traffic pattern, many local switches 10 may share one (or more for redundancy) Internet server 12. In such case, the routing tables on the local switches 10 sharing the same Internet server 12 will all point to the same internet server 12 as the next hop.

The Internet server 12 includes several components, including a data processor/controller 18 for processing information, tone detection circuitry 20 for recognizing dialed multi-frequency tone signals indicative of well known telephone dialing keypads of numerals or groups of three alphabetic letters, and a text-to-speech (TTS) system 22. Data input to the data processor/controller 18 may come from the local switch 10 (the caller), from the tone detection circuits 20 or from the TTS system 22. Programs/algorithms and temporary memory for formulating queries and responses to callers is shown as program/data memory 24, which is connected to the processor 18.

Web pages (in general) contain a combination of text, voice, and graphics. The present invention will not provide graphical information, but will simply operate in “text-mode.” However, the text received from the Internet 8 must be converted to speech before it can be relayed to the user over the telephone 2. The text-to-speech (TTS) system 22 accomplishes this function. In using a typical TTS system 22, the Internet server 12 receives text from the Internet 8. The text is transmitted to the TTS system 22. Next, the TTS system 22 analyzes the text and generates a synthesized speech signal that is transmitted to an acoustic output device, such as the telephone 2. The acoustic output device (or telephone 2) outputs the synthesized speech signal to the user.

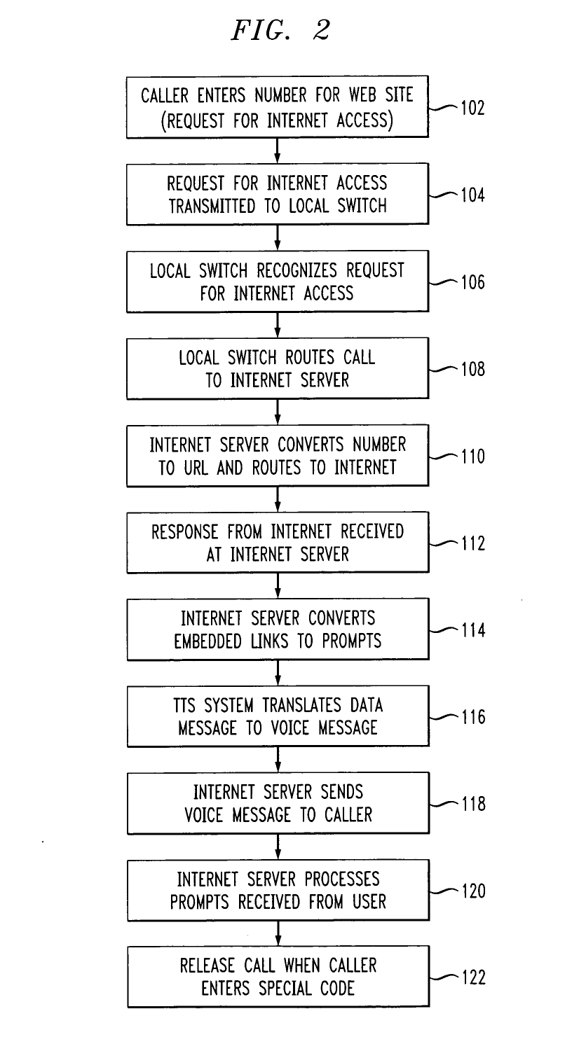

In the preferred embodiment, the Internet server 12, the routing database 16, the processor 18, the tone detection circuits 20, the TTS system 22, and the program/data memory 24 are all processor-based devices with data link interfaces for coupling together as described above and shown in FIG. 1. An algorithm for the present invention is shown in flowchart form in FIG. 2. Software representing that or an equivalent flowchart may preferably reside in memory 24 in the Internet server 12. However, the software may also be distributed throughout the network.

Initially, the caller places a call to a Web site such as www.lucent.com (step 102). This Web site is exemplary only and may be otherwise suitably chosen for the service. Typically, the caller places the call by going off hook, receiving dial tone from the LEC and actuating the corresponding alphanumeric keys of their touchtone keypad of their telephone 10. The destination number of the Web site preferably includes (a) a feature activation code (e.g., *0), (b) numbers representing the URL of the Web site, and (c) a code to signal the end of the URL (e.g., *9).

One way to enter alphanumeric characters and special characters (for the URL) over the keypad would be to enter two digits for each character, number, a special character (such as a period, a comma, an asterisk, etc.) For numbers, the first digit can be same as the digit followed by the number 0. Almost every telephone keypad has three letters (not including Q and Z, which not all phones have) on each digit. These letters can be entered as the digit following by 1, 2, or 3 depending upon whether it's the first, second, or the third letter on that digit. Numbers 4 and above will be used as a second digit for Q, Z and special characters. Table 1 below, which would preferably be stored in memory 24, shows one such mapping, although it is to be understood that other options may be available.

TABLE 1

| NUMBER/LETTER/ | | |
|---|---|---|
| CHARACTER/REQUEST | | |
| TO BE ENTERED ON | FIRST | SECOND |
| ALPHANUMERIC KEYPAD | KEY | KEY |
| Initiating a call for Web access | * | 0 |
| Numbers 0-9 | 0-9 | 0 |
| Letters A, B, or C | 2 | 1, 2, or 3 |
| Letters D, E, or F | 3 | 1, 2, or 3 |
| Letters G, H, or I | 4 | 1, 2, or 3 |
| Letters J, K, or L | 5 | 1, 2, or 3 |
| Letters M, N, or O | 6 | 1, 2, or 3 |
| Letters P, R, or S | 7 | 1, 2, or 3 |
| Letters T, U, or V | 8 | 1, 2, or 3 |
| Letters W, X, or Y | 9 | 1, 2, or 3 |
| Letter Q | 7 | 4 |
| Letter Z | 9 | 4 |
| . (“dot”) | 1 | 1 |
| @ (“at”) | 1 | 2 |
| Ending the call | * | 9 |

Thus, using Table 1 as a base, to access the Web site located at www.lucent.com, the caller would enter the following string as a destination number: *0 (to begin a URL string)—919191 (for “www”)—11 (for “.”)—538223326281 (for “lucent”)—11 (for “.”)—236361 (for “com”)—*9 (to end a URL string). The string destination number entered by the caller, along with the caller's ID (i.e., originating phone number), is transmitted to the local switch 10 (step 104). Alternatively, the most commonly used URLs may be saved as speed dial keys on the telephone 2.

The local switch 10 recognizes that the destination number is not within its control (i.e., a request for Internet access has been made) by comparing the feature activation code (e.g., *0) to information stored in a routing table in the database 16 (step 106). This functionality is well known in the field. Thus, the switch 10, in essence, acts as a “URL interceptor.” As a result, the local switch 10 routes the call to the Internet server 12, based on the information retrieved from the database 16, for processing (step 108).

The Internet server 12 converts the destination number to the regular URL of the Web site (i.e., www.lucent.com). That is, the Internet server 12 receives the numbers (two digits per URL character in our example). The Internet server 12, through the processor 18 and memory 24, simply converts each digit pair to a character as emphasized in Table 1. Next, the Internet server 12 sends the URL to the Internet 8 using packet switching as known to those skilled in the art (step 110). The response from the Internet 8 is received at the Internet server 12 (step 112). The response is in the form of digital information. This digital information includes the Web page contents (text, voice, and graphics) as well as commands (hyperlinks). A hyperlink represents an instruction to jump to a new Web page. The contents and the commands will be processed differently in the Internet server 12 as explained later.

The Internet server 12, through the processor 18 and the TTS system 22, converts any embedded links to prompts (e.g., “Press 1 to link to Human Resources.”).(step 114). More particularly, the information retrieved from the Web page contains two types of information: a) hyperlinks and b) non-hyperlinks. The Internet server 12 creates a table of all hyperlinks (leaving locations for Back, Next, Home, etc.) for the Web page. It also maintains a current pointer, which represents how much of the content on the Web page has been “read” to the caller. Initially, the current pointer is set to 0, and then it is repositioned as the page is read to the caller. Then, the server 12 converts part of the non-hyperlink text (a couple of sentences in the example above) to speech, plays it to the caller, and repositions the current pointer. It also plays the prompts, maintains the next set of prompts to play, and so on, with each prompt referring to each table location for jumping to the corresponding hyperlink.

Thus, for example, the Internet server 12 may play (or “read”) to the caller a couple of sentences at a time and then pause, giving the caller an option to “continue” (where a default would occur if no response is received for a pre-defined time period), or any other options valid on that page. An example for www.lucent.com may be: “Press 1 to ‘Continue,’ Press 2 for ‘Customers,’ Press 3 for ‘investors,’ Press 4 for ‘career opportunities’ or Press 9 for more options.”

Alternatively, the Internet server 12 may continue reading the prompts to the caller, but also allow the caller to press a key (e.g., 1) at any time, which, in turn, causes the Internet server 12 to pause and provide all the applicable options.

Preferably, the two options described above are combined. For example, pressing “*” could mean back page; pressing “#” could mean next page; pressing “0” could mean home page which could be customizable for each caller; pressing “00” could mean stop, and so on. The Internet server 12 would convert all hyperlinks for the current page as valid prompts (plus Previous Page, Next Page, and Home Page), which get refreshed on every new Web page load.

The TTS system 22 translates the entire message (including any additional prompts) to a voice message in the usual manner (step 116). There are many types of software systems known in the art that reliably convert text to speech. A few examples of such software include: Hal Screen Reader for Windows, Cicero Text Reader, outSPOKEN 9.0 & 9.2 for Macintosh, and ALVA Braille Terminal 320. The Internet server 12 then utilizes the caller ID information to route the voice message back to the caller, through the local switch 10 (step 118). During the call, the Internet server 12 processes the prompts received from the caller (step 120).

A preferred way to convert the hyperlinks from the Web page to prompts and then match those with the caller's responses to jump to the appropriate Web page is as follows. First, the Internet server 12 creates a table (which is refreshed for each page). This table contains, at a minimum, an entry number(1, 2, 3 . . . ) where there is a unique number for each allowed hyperlink on the Web page (while allowing extra entries for Home, Back, Next, etc.), the name to display (or read) to the caller, and the actual address of the Web page to jump to. The name to read is read out to the caller along with the entry number to enter. As an example, if the Web page has three hyperlinks (Products, Customers, Career Opportunities), then the table will have three of these entries, and the prompts displayed to the user would be: “Press 1 to jump to Products, Press 2 to Jump to Customers, or Press 3 to Jump to Career Opportunities.” The display name portion (underlined in this example) could be read out in a slightly different tone. Each of these entries in the table would contain the actual address of the Web page to jump to upon prompt activation by the caller. Steps 112-120 are repeated until the caller enters a special code to release the call (step 122). Thus, the present invention allows a caller to “surf” the Web in real time with a standard telephone.

The invention has been described with reference to the preferred embodiments. Obviously, modifications and alterations will occur to others upon reading and understanding the preceding detailed description of the preferred embodiments. It is intended that the invention be construed as including all such modifications and alterations insofar as they come within the scope of the appended claims or the equivalence thereof.

1. In a telecommunications network, a method of providing real-time Internet access to a caller having only a standard telephone and plain old telephone service, comprising the steps of:
receiving at a local switch a destination number representing a request for Internet access from the caller;
routing the call to an Internet server for providing the Internet access;
converting the destination number to a URL (universal resource locator) at the Internet server;
routing the URL from the Internet server to the Internet;
receiving a response from the Internet at the Internet server, the response including digital information;
converting the digital information in the response to a voice message, the voice message including information from the Web site and prompts for the caller; and
routing the voice message to the caller.

2. The method defined in claim 1, further comprising the step of releasing the call when the local switch recognizes that a special code has been entered by the caller.

3. The method defined in claim 1, wherein the destination number includes a feature activation code and a URL code.

4. The method defined in claim 1, wherein the Internet server includes a data processor for processing information, tone detection circuitry for recognizing dialed multi-frequency tone signals, a text-to-speech system for generating voice messages and announcements to be played to the caller, and data memory for formulating queries and responses to the caller.

5. The method defined in claim 1, wherein the local switch includes a URL interceptor for routing the call to the Internet server.

6. The method defined in claim 2, wherein the Internet server includes a data processor, tone detection circuitry, a text-to-speech system, and data memory.

7. The method defined in claim 6, wherein the destination number includes a feature activation code and a URL code.

8. The method defined in claim 7, wherein the Internet server includes a data processor, tone detection circuitry, a text-to-speech system, and data memory.

9. The method defined in claim 8, wherein the local switch includes a URL interceptor for routing the call to the Internet server.

10. A system for providing real-time Internet access to a caller having only a standard telephone and plain old telephone service, comprising:
means for receiving at a local switch a destination number representing a request for Internet access from the caller;
means for routing the call to an Internet server for providing the Internet access;
means for converting the destination number to a URL at the Internet server;
means for routing the URL from the Internet server to the Internet;
means for receiving a response from the Internet at the Internet server, the response including digital information;
means for converting the digital information in the response to a voice message, the voice message including information from the Web site and prompts for the caller; and
means for routing the voice message to the caller.

11. The system defined in claim 10, further comprising means for releasing the call when the local switch recognizes that a special code has been entered by the caller.

12. The system defined in claim 10, wherein the destination number includes a feature activation code and a URL code.

13. The system defined in claim 10, wherein the Internet server includes a data processor for processing information, tone detection circuitry for recognizing dialed multi-frequency tone signals, a text-to-speech system for generating voice messages and announcements to be played to the caller, and data memory for formulating queries and responses to the caller.

14. The system defined in claim 10, wherein the local switch includes a URL interceptor for routing the call to the Internet server.

15. The system defined in claim 11, wherein the Internet server includes a data processor, tone detection circuitry, a text-to-speech system, and data memory.

16. The system defined in claim 15, wherein the destination number includes a feature activation code and a URL code.

17. The system defined in claim 16, wherein the Internet server includes a data processor, tone detection circuitry, a text-to-speech system, and data memory.

18. The system defined in claim 17, wherein the local switch includes a URL interceptor for routing the call to the Internet server.
